(19) United States
(12) Patent Application Publication
(10) Pub. No.: US 2002/0121852 A1
(43) Pub. Date: Sep. 5, 2002

(54) Color cathode ray tube

(76) Inventors: Sung-Dae Kim, Seoul (KR); Ho-Jun Lee, Seoul (KR)

Correspondence Address: BIRCH STEWART KOLASCH & BIRCH, PO BOX 747, FALLS CHURCH, VA, 22040-0747, US

(21) Appl. No.: 09/933,895

(22) Filed: Aug. 22, 2001

(30) Foreign Application Priority Data
Dec. 22, 2000 (KR) P2000-80447

(51) Int. Cl. H01J 29/80

(52) U.S. Cl. 313/407

(57) ABSTRACT

The present invention relates to a damper wire of a tension type shadow mask in a cathode ray tube. The color cathode ray tube having a panel on which a frame is installed, a shadow mask fixed on the frame with a predetermined curvature and a plurality of damper wires mounted on the shadow mask, each of the damper wires fixed by means of a damper spring, which comprising the end portion of damper wire fixed in said damper spring positioning on or above an extension line of said predetermined curvature that is contacted with the end of said shadow mask.

The cathode ray tube according to the present invention effectively suppresses the howling of the shadow mask and removes the problem suffered conventionally in case of the grill type shadow mask that the grills deviated due to the increased pressing or friction force with the shadow mask are not returned to their original form,

### BACKGROUND OF THE INVENTION

1. Field of the Invention

The present invention relates to a color cathode ray tube with a tension type shadow mask and more particularly, to the fixed positions of a plurality of damper wires in a color cathode ray tube having a tension type shadow mask, wherein the damper wires cross in manner to be contacted with the upper side of the shadow mask, with a result that howling which is caused due to the vibration of the shadow mask is suppressed.

2. Description of the Related Art

FIG. 1 shows a configuration of a general color cathode ray tube. In configuration, a panel 1 as front glass and a funnel 2 as back glass are coupled to thereby form a vacuum space, and a fluorescent screen 4 on which fluorescent materials of red, green and blue colors are spread is provided on the inside of the panel 1, for performing a light emitting operation. An electron gun is coupled to a neck part of the funnel 2, for generating electron beams 6, such that the light is emitted from the fluorescent screen 4, and a shadow mask 3 is disposed at a predetermined distance from the inside of the panel 1, for discriminating the fluorescent materials of red, green and blue colors, respectively, thereby emitting the light from the respective fluorescent materials. In addition, a frame 7 and a spring 8 are provided in order to support the shadow mask on the panel 1, and an inner shield 8 is fixed on a frame of the cathode ray tube, such that the cathode ray tube is not affected from an external earth magnetic field during its operation.

The interior of the cathode ray tube is at a high vacuum state and therefore, if an external impact is applied, it may be easily exploded. To prevent such the explosion, the panel 1 is designed such a structural strength as to resist to atmospheric pressure. Also, a reinforcing band 11 is mounted on the skirt of the panel 1, for the purpose of distributing the stress applied to the tube being in the high vacuum state, thereby providing improved explosion-proof performance.

In operation, the electron beams 6 generated from the electron gun provided on the neck part of the funnel 2 are collided on the fluorescent screen 4 on the inside of the panel 1 by virtue of the positive voltage applied to the cathode ray tube. At this time, the electron beams 6 are deflected up and down and right and left by means of a deflection yoke 5 before reaching the fluorescent screen 4, thereby forming a whole screen.

Referring to FIGS. 2 to 4, a plurality of damper wires 15 are installed along the curvature of the shadow mask 3, for the purpose of reducing the vibration of the shadow mask in the cathode ray tube with the tension type shadow mask. Each of the damper wires 15 is supported by a damper spring 14. Usually, the number of damper installed wires 15 is 3.

To explain the mounting height for the damper wire 15, the coordinates are first set as shown in FIG. 3, in which the horizontal axis on the shadow mask, that is, the axis to the long side, is set as an axis X and the axis to the short side on the shadow mask is set as an axis Y Tension is applied to the direction of the axis Y and the curvature formation is made to the direction of an axis Z toward the panel side.

The above-defined coordinate axes are the coordinate system that is applied in the following discussion.

The reference line relative to the height for mounting the damper wire 15 is the tangent's extension line of the end face of the shadow mask with the curvature as shown in FIG. 3. This is shown on an axis −y in the shadow mask assembly in a direction of the arrow mark shown in FIG. 5a. That is to say, the setting value of the end face of the shadow mask in the same height as the extension line of the tangent is ‘0’, the setting value thereof in case that the damper wire is mounted upward is ‘positive (+)’, and the setting value thereof in case that the damper wire is mounted downward is ‘negative (−)’, as shown in FIG. 5b.

The height determined by mounting the damper wire upward or downward relative to the extension line of the tangent on the end face of the shadow mask is denoted by a reference symbol Δh. The size of the height Δh represents the quantity of length for the height from the mounted position of the damper wire to the tangent's extension line of the end face of the shadow mask, as shown in FIG. 5b.

Referring to the damping mechanism of the damping wire for explaining the operation of the damper wire, the damper wire firstly serves to improve the strength of the shadow mask. If the damper wire is forced to press the shadow mask to which tension has been applied, the shadow mask is essentially under strong tension. Really, the amount of tension applied is used such that the inherent frequency of the shadow mask is increased by about 1 Hz to 3 Hz. As the frequency has been increased, an amount of the vibration is decreased. However, most of the shadow masks have the inherent frequency of 150 Hz. It can be therefore understood that the increasing by about 1 Hz to 3 Hz does not give any effect on the vibration of the shadow mask. In this way, the inherent frequency has proportional relation to the square root of the strength. If the tension of the damper wire is greatly high and the mounting height Δh is excessively low, the strength of the shadow mask is improved. Strictly speaking, the damper wire does not have any energy absorbing mechanism capable of absorbing the vibration generated from the shadow mask and only reduces the amplitude with the strength increased.

However, the above characteristic of the damper wire arises the following problems: If the shadow mask is excessively pressed, screen characteristics are deteriorated; since the damper wire is substantially very fine, it is apt to be broken; and with the excessive tension, it is difficult to weld the damper wire. In case of the cathode ray tube adopting an aperture grill type shadow mask, the grills once scattered due to the vibration of the shadow mask is not returned to their original position because of the excessive tension of the damper wire. As a consequence, the grills are kept in irregularly spaced relation to each other, which will give a serious affect to the screen characteristics.

And, the damper wire secondly serves to damp the friction with the shadow mask surface. FIG. 9 shows the vibration damping mechanism at the height where the damper wire is mounted. The damper wire is attached by means of the damper spring on the both sides thereof, thereby making it possible to be moved in a length direction thereof And, the shadow mask is vibrated, thereby generating the friction with the damper wire.

Actually, the above mechanism exhibits an excellent damping force against the vibration of the shadow mask. The mechanism has the energy absorption mechanism where the vibration of the shadow mask is absorbed. That is, if the friction between the shadow mask and the damper wire is generated, it is converted into heat energy.

The friction mechanism does not well operate, even if the tension of the damper wire becomes higher or the mounting height thereof becomes lower. In this case, an appropriate amount of tension and the height for mounting the damper wire having an appropriate length are all needed.

Specifically, if the position where the damper wire is mounted is excessively low under given tension conditions of the damper wire, the reciprocal pressure between the damper wire and the shadow mask is increased, thereby not generating relative movement between the damper wire and the shadow mask, such that the damper wire and the shadow mask are moved as an integral body to each other. The friction damping force can convert the vibration energy into the heat energy only with the friction generated between the damper wire and the shadow mask. Due to the suppression of the friction movement, however, the damper wire fails to exert its vibration damping function.

And, the damper wire thirdly serves to damp the vibration of the shadow mask with the collision against the shadow mask. The damper wire has the different inherent frequency from the shadow mask, and the shadow mask has the tension distribution in the shape of “U” in the direction of axis X in FIG. 5a, such that different inherent frequencies exist on the part of the shadow mask in the direction of axis X. Therefore, if the vibration with a predetermined frequency is applied from the outside, the vibration is locally generated only on the shadow mask part corresponding to the predetermined frequency. Thereby, the shadow mask part where the local vibration has been generated collides against the damper wire. Under the above collision mechanism, the heat energy is generated, thereby applying a vibration damping force to the shadow mask.

It is not desirable that the height for mounting the damper wire is substantially low, in view of the collision mechanism. If the energy disappearing due to the collision is to be high, the collision speed should be preferably fast.

An object vibrating exhibits a highest vibration speed when it passes a neutral position. If the vibration displacement is generated at ‘+a’ by ‘−a’, the neutral position means the vibration displacement of ‘0’ at the center point thereof.

However, if the tension of the damper wire is increased, as shown in FIG. 10, the damper wire presses the neutral face of the shadow mask, with a result that the damper wire collides against the shadow mask before it reaches the neutral position of the shadow mask. This causes the damper wire not to collide against the shadow mask at the position where the shadow mask is at a maximum vibration speed, which results in the decrement of the collision energy. If the height for mounting the damper wire is substantially low, thereby, the damper wire exhibits a reduced vibration damping force for the shadow mask.

As one example of the prior art, Japanese patent laid-open application No. 10-172449 discloses the definition of a parameter ‘α’ and the range thereof for the purpose of removing the portion where the shadow mask and the damper wire are not contacted with each other. As another example of the prior art, Japanese patent laid-open application No. 11-144637 discloses the conditions of the damper wire spring which can be prevented that due to damper wire spring transformed by thermal processing, the damper wire and the shadow mask are not contacted with each other. According to the prior art mentioned above, it can be appreciated that the damper wire and the shadow mask should be necessarily contacted with each other.

As noted, however, it has been not proved whether or not the vibration damping mechanism of the damper wire with the friction against the shadow mask exhibits more excellent damping effect than the vibration damping mechanism of the damper wire with the collision with the shadow mask. It should be therefore noted that the lowering the height for mounting the damper wire is not suitable.

### SUMMARY OF THE INVENTION

It is an object of the present invention to provide a color cathode ray tube with a plurality of damper wires that sets the height for mounting the damper wires to the height of ‘0’ or to the height of a positive value unlike a negative value in the prior art, thereby improving friction and collision characteristics between the damper wires and the shadow mask, such that the damping force of the shadow mask will be increased.

To accomplish this object of the present invention, there is provided a color cathode ray tube having a panel on which a frame is installed, a shadow mask fixed on the frame with a predetermined curvature and a plurality of damper wires mounted on the shadow mask, each of the damper wires fixed by means of a damper spring, comprising the end portion of damper wire fixed at said damper spring positioning on or above an extension line of said predetermined curvature that is contacted with the end of said shadow mask.

Preferably, the ends of each of the damper wires and the shadow mask are positioned in manner not to be contacted with each other on the both ends thereof in a direction to which the tension of the shadow mask is not applied.

### BRIEF DESCRIPTION OF THE DRAWINGS

FIG. 1 shows a sectional view of a general color cathode ray tube;

FIG. 2 shows a sectional view of a tension type shadow mask assembly in the color cathode ray tube;

FIG. 3 shows the mounting state of the damper wires;

FIG. 4 shows the structure of an aperture grill type shadow mask assembly;

FIGS. 5a and 5b show the reference for the height at which the damper wire is mounted and the definition of the reference symbols;

FIG. 6 shows the height at which the damper wire is mounted in the prior art;

FIG. 7 shows the height at which the damper wire is mounted according to the present invention;

FIG. 8 shows the tension distribution of the shadow mask on the axis X according to the present invention;

FIG. 9 shows a vibration damping mechanism at the height where the damper wire is mounted;

FIG. 10 shows a collision damping mechanism at the height where the damper wire is mounted;

FIG. 11 shows the experiments on the height where the damper wire is mounted according to the present invention;

FIG. 12 shows a vibration experiment device according to the present invention;

FIG. 13 shows the gap sensing points and the inherent frequencies thereof according to the present invention;

FIG. 14 shows the vibration experiment results according to the present invention; and

FIG. 15 shows the howling experiment results according to the present invention.

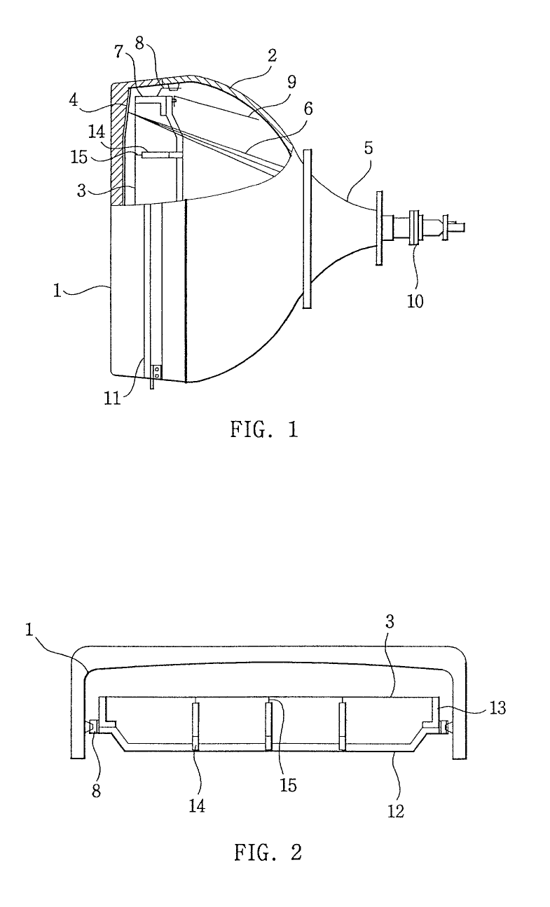

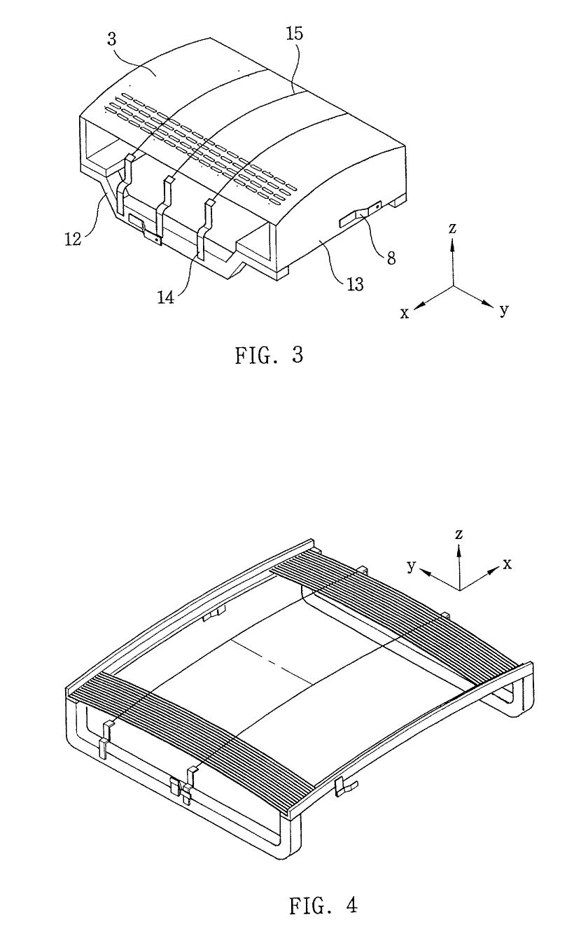

### DETAILED DESCRIPTION OF THE PREFERRED EMBODIMENTS

The preferred embodiments of the present invention will be in detail discussed with reference to the accompanying drawings.

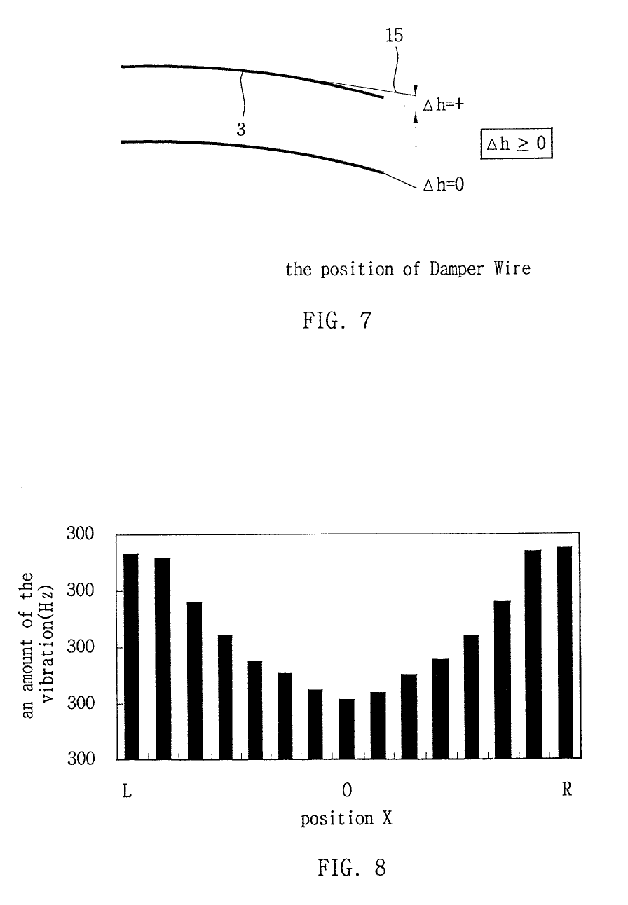

A color cathode ray tube according to the present invention is constructed, as shown in FIG. 7, in such a fashion that the height Δh at which the damper wire is mounted is set over ‘0’, with a result that the damper wire is slightly contacted with the shadow mask on the end face of the shadow mask or that the damper wire is not contacted with the shadow mask on the end face thereof.

In the tension type shadow mask, the howling generated due to the vibration of the shadow mask is not exhibited on the area where the inherent frequency corresponding to the end portion of the shadow mask exists. As shown in FIG. 8, the tension type shadow mask has the tension distribution in the direction of axis X in the shape of ‘U’, where the tension is increased towards the both sides based on that X=0.Thereby, the shadow mask exhibits the more increased inherent frequencies on the both end portions thereof when compared with the other portions, such that both end portions of the shadow mask has such the tension strength as not to generate the howling, even without having the damper wire.

When it is assumed that the length of the shadow mask to the one side at the center portion thereof is ‘1’, hence, the howling is generated on the area up to a point corresponding to about ⅘, that is, point positioned slightly inside toward center thereof than both ends thereof.

By this reason, the present invention is aimed to exhibit an excellent vibration damping characteristic on the portion where the howling may be generated. To this end, the height Δh at which the damper wire is mounted is set as a positive value. However, the howling may be generated on the both ends of the shadow mask in case where the inherent frequencies on the both ends thereof are set substantially low. In this case, the height Δh according to the present invention is set as ‘0’.

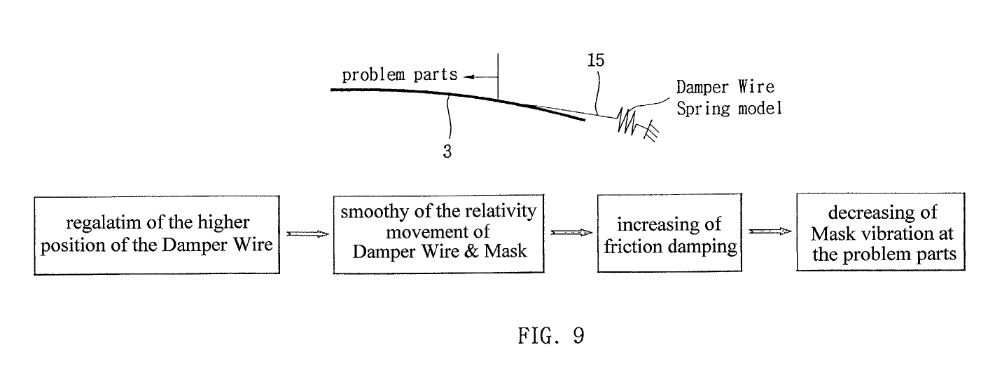

The improved damper wire mounting structure according to the present invention permits the friction damping energy between the damper wire and the surface of the shadow mask to be increased. As shown in FIG. 9, if the reciprocal pressure between the damper wire and the shadow mask becomes high, the friction energy therebetween is not increased and actually, the friction force therebetween is excessively strong, such that the reciprocal movement between the damper wire and the shadow mask is not generated. In this state, therefore, the friction energy is not obtained.

Accordingly, if the reciprocal pressure between the damper wire and the shadow mask becomes low, the friction force therebetween is reduced, thereby generating the reciprocal movement between the damper wire and the shadow mask. Under the above state, the friction energy that is proportional to the size of the vibration displacement Δx or the vibration speed Δx′ is obtained, such that the vibration damping rate is increased.

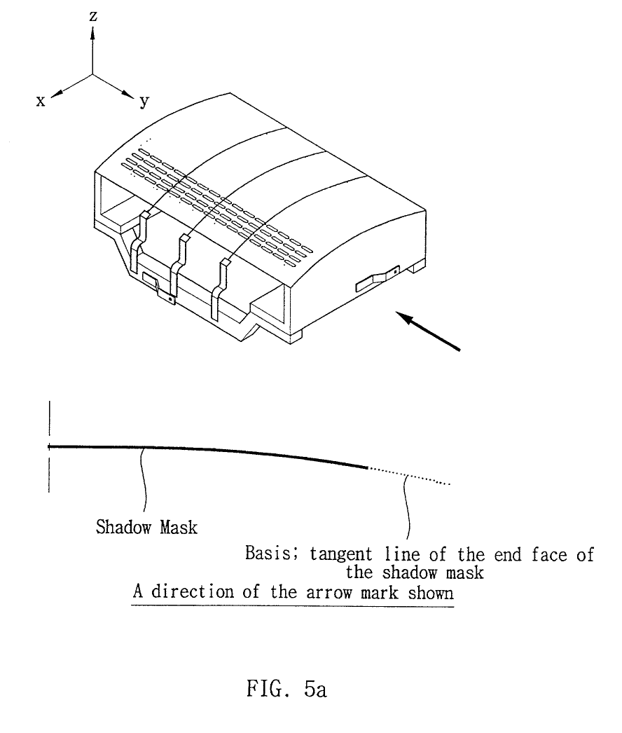

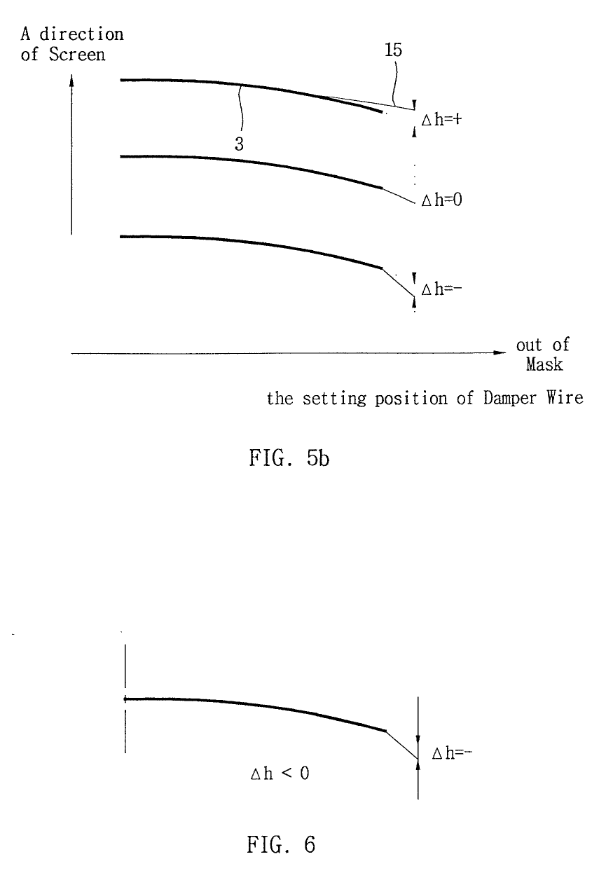

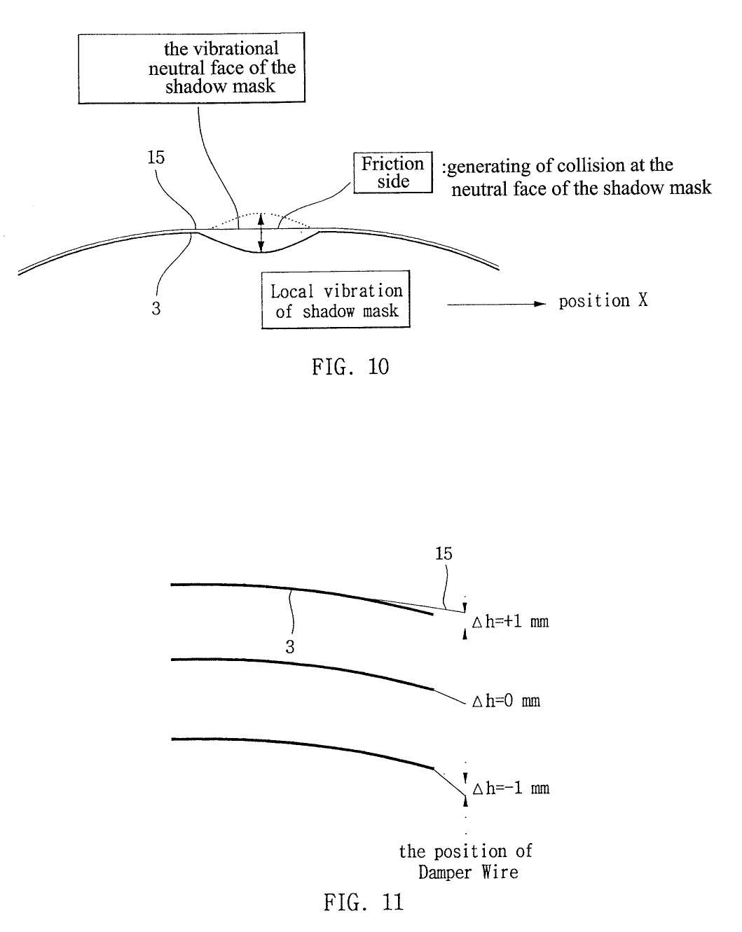

Further, the improved damper wire mounting structure according to the present invention permits the collision damping energy between the damper wire and the surface of the shadow mask to be increased, as shown in FIG. 10. As previously discussed, the damper wire has the different inherent frequency from the shadow mask, and the shadow mask has the tension distribution in the shape of “U” in the direction of axis X in FIG. 5a, such that different inherent frequencies exist on the part of the shadow mask in the direction of axis X. Therefore, if the vibration with a predetermined frequency is applied from the outside, the vibration is locally generated only on the shadow mask part corresponding to the predetermined frequency. Thereby, the shadow mask part where the local vibration has been generated collides against the damper wire. Under the above collision mechanism, the heat energy is generated, thereby applying a vibration damping force to the shadow mask.

Under the above mechanism, if the height at which the damper wire is mounted is somewhat higher than that in the conventional practice to thereby reduce the pressure against the shadow mask, the damper wire collides with the shadow mask on the vibration neutral position at which the shadow mask is at a maximum vibration speed. At this time, a great amount of collision energy is generated, thereby permitting the vibration of the shadow mask to be effectively decreased.

The key point in the present invention is placed in defining the height at which the damper wire is mounted. That is to say, in case where the damper wire is slightly contacted with the shadow mask on the both ends of the shadow mask or in case where the damper wire is not contacted therewith, the vibration of the shadow mask can be effectively reduced.

Therefore, the reduction of the vibration of the shadow mask does not have any relation with the installation and non-installation of the damper spring. In another embodiment of the present invention, in other words, the height at which the damper wire is mounted is set such that the damper wire is slightly contacted with the shadow mask on the both ends of the shadow mask or not contacted therewith, without having any damper spring or with a damper wire supporting part in another structure.

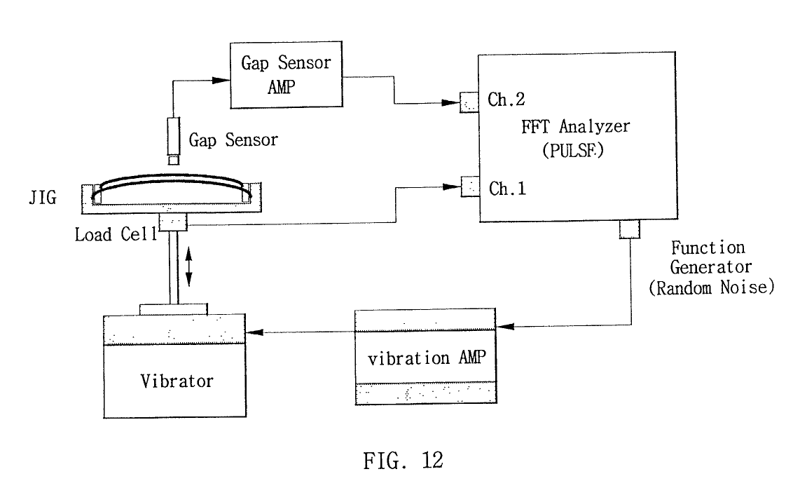

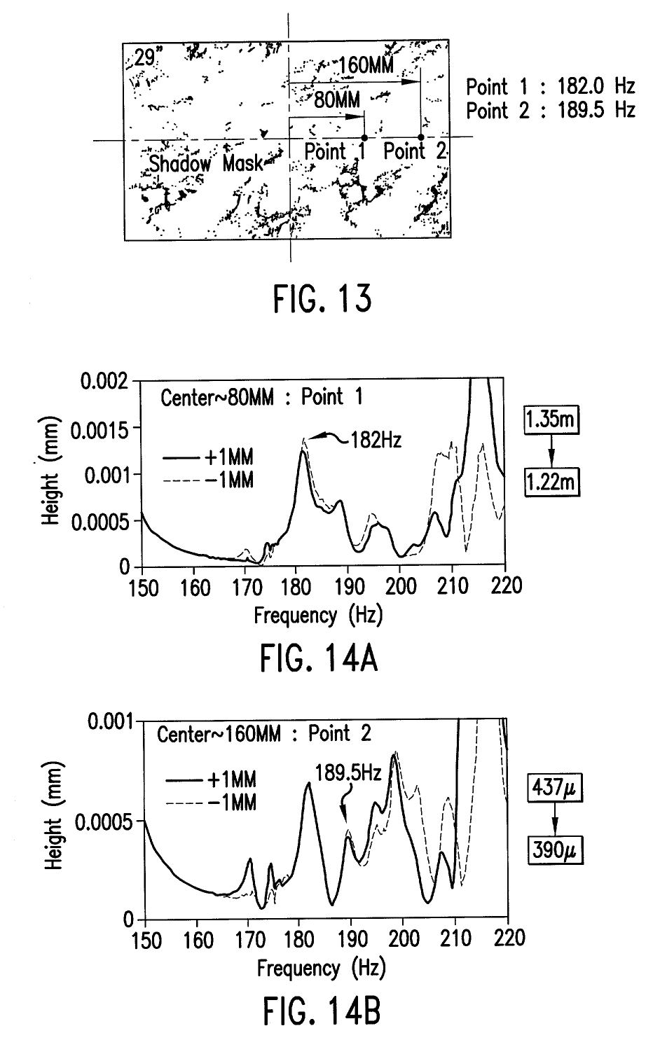

To test the effect of the vibration of the shadow mask according to the height at which the damper wire is mounted, in case that the height at which the damper wire is mounted is −2 mm, −1 mm, 0 mm, +1 mm and +2 mm, respectively, as shown in FIG. 11, the results are obtained by using a vibration experiment device as shown in FIG. 12.

The vibration experiment device is manufactured in such a manner that the frame and the shadow mask are fixed on a jig, as shown in FIG. 12 and under the above state, the test is carried out in the air. The jig in the drawing is substituted by the panel in the cathode ray tube. The test method comprises measuring an amount of vibration of the shadow mask by using a gap sensor, while vibrating the center of the jig corresponding to the panel by using a vibrator and comparing the characteristics obtained according to the height, based on the measured amount of vibration.

The amount of vibration of the shadow mask compared in the above test is a frequency response function (hereinafter, referred to as FRF) that is defined as the displacement of vibration generated to the force of vibration applied. That is,

FRF(f)=X(f)/F(f)

wherein, the ‘f’ represents frequency, the ‘X’ displacement and the ‘F’ force.

Even if input force is varied, the amount of vibration thereto is represented by a ratio, thereby achieving accuracy in the test result. Since the gap sensor measuring the amount of vibration (displacement) of the shadow mask is fixed on the jig corresponding to the panel, it is understood that the measured vibration amount is a relative amount of vibration to the panel.

Two points in the area where the howling is seriously generated are selected as a target point in the present test. The two points include a point 1 within the length of 80 mm in the horizontal direction (in the direction of axis X) from the center thereof and a point 2 within the length of 160 mm in the horizontal direction (in the direction of axis X) from the center thereof. As discussed in the above, the tension distribution on the axis X in the tension type shadow mask is in the shape of ‘U’, where the tension is increased towards the both sides based on the center of the axis X. Therefore, the each of parts on the shadow mask have different inherent frequencies from each other, thereby causing the shadow mask to be locally vibrated. The points 1 and 2 selected as the target point of the test according to the present invention have the inherent frequencies of 182.0 Hz and 189.5 Hz. Therefore, the FRF values corresponding to the inherent frequencies on the points 1 and 2 are obtained according to the height at which the damper wire is mounted. Based on the obtained FRF values, the vibration damping characteristics of the shadow mask are compared between the present invention and the prior art.

FIG. 14 is a graph illustrating the vibration experiment results according to the present invention, and the FRF values obtained according to the height at which the damper wire is mounted are given by the following Table:

| | | | | −1 mm (con- | |
|---|---|---|---|---|---|
| | | | | ventional | |
| | +2 mm | +1 mm | 0 | method) | −2 mm |
| Point 1 | 1.19 mm | 1.22 mm | 1.25 mm | 1.35 mm | 1.26 mm |
| (182 Hz) | | | | | |
| Point 2 | 470 μm | 390 μm | 399 μm | 437 μm | 406 μm |
| (189.5 Hz) | | | | | |

As apparent from Table, a highest FRF value is obtained at the height of −1 mm in the conventional method and it can be therefore understood that the height of −1 mm exhibits a poor vibration damping characteristic. And, the pressing by the damper wire is caused at the height of −2 mm, thereby obtaining an improved strength. Therefore, the height of −2 mm exhibits a good vibration damping characteristic when compared with the height of −1 mm.

It is, however, found that the vibration damping characteristic at the height of −1 mm or −2 mm is inferior to that at the height of 0 mm or +1 mm. At the point 1, the height of +2 mm exhibits an excellent vibration damping characteristic of the shadow mask. The height of +2 mm at the point 2 exhibits a very poor vibration damping characteristic. The reason is that the height where the damper wire is mounted is too high, such that the damper wire is not contacted with the shadow mask.

FIG. 14 shows the graph for the FRF values as obtained in Table. When comparing the FRF characteristics of the frequencies corresponding to the points 1 and 2, it can be understood that the height of +1 mm exhibits more improved vibration damping characteristic than the height of −1 mm in the conventional method.

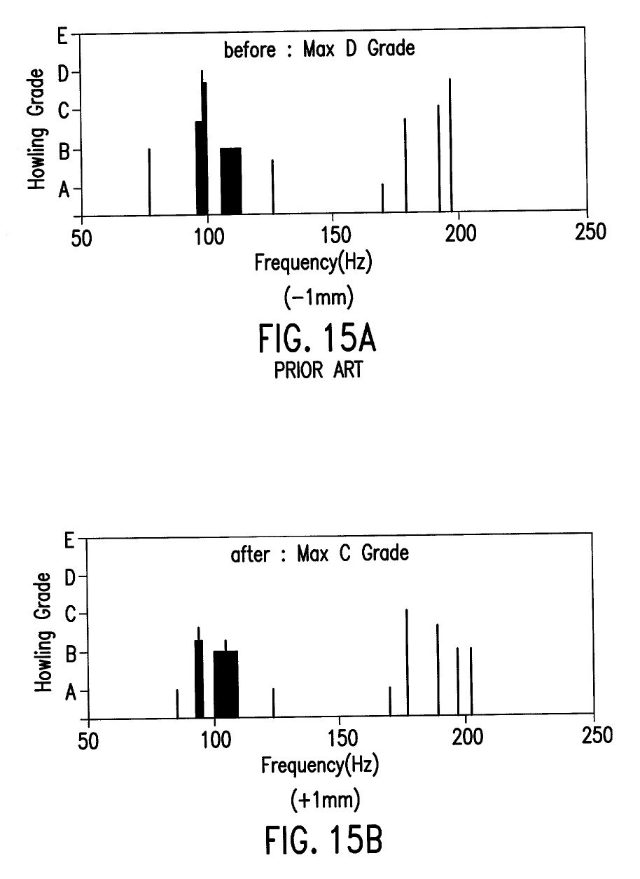

FIG. 15 shows the graphs obtained by applying a howling test to the cathode ray tube of the present invention where the damper wire is mounted at the height of +1 mm and the conventional cathode ray tube where the damper wire is mounted at the height of −1 mm. In the graphs, the vertical axis represents the howling grades, on which the grade A exhibits an excellent vibration damping characteristic and the horizontal axis represents the frequency. When comparing the Table with the graphs in FIG. 15, it can be understood that the cathode ray tube of the present invention where the damper wire is mounted at the height of +1 mm exhibits the howling characteristic upgraded by one grade than that of the conventional method.

In addition, the cathode ray tube of the present invention where the damper wire is mounted at the height of +1 mm is capable of removing the problem suffered conventionally in case of the grill type shadow mask that the grills deviated due to the increased pressing or friction force with the shadow mask are not returned to their original form.

While the present invention has been described with reference to a few specific embodiments, the description is illustrative of the invention and is not to be construed as limiting the invention. Various modifications may occur to those skilled in the art without departing from the spirit and scope of the invention as defined by the appended claims.

What is claimed is:

1. A color cathode ray tube having a panel on which a frame is installed, a shadow mask fixed on said frame with a predetermined curvature and a plurality of damper wires mounted on said shadow mask, each of said damper wires fixed by means of a damper spring, comprising:
the end portion of damper wire fixed in said damper spring positioning on or above an extension line of said predetermined curvature that is contacted with the end of said shadow mask.

2. The color cathode ray tube according to claim 1, wherein the end portion of the damper wires and said shadow mask are positioned in manner not to be contacted with each other on the both ends thereof in a direction to which the tension of said shadow mask is not applied.
